(19) United States
(12) Patent Application Publication
(10) Pub. No.: US 2019/0108690 A1
(43) Pub. Date: Apr. 11, 2019

(54) SYSTEMS FOR COUNTING PASSENGERS

(71) Applicant: APACE RESOURCES AS, OSLO (NO)

(72) Inventors: Bjørn Kjetil MØLMANN, Lillestrøm (NO); Harald FURU, Oslo (NO)

(21) Appl. No.: 16/087,760

(22) PCT Filed: Apr. 5, 2017
(86) PCT No.: PCT/NO2017/000010

§ 371 Date: Sep. 24, 2018

(30) Foreign Application Priority Data
Apr. 5, 2016 (NO) 20160541

(51) Int. Cl. G07B 15/06; H04L 9/32; H04L 9/30; H04W 12/04; B60N 99/00

(52) U.S. Cl. CPC G07B 15/063; H04L 9/3263; B60N 99/00; H04W 12/04071; H04L 9/30

(57) ABSTRACT

A system and method for counting passengers in a road vehicle (10) comprises a vehicle server (160) within the vehicle (10). At the start of a journey, the vehicle server sends (210) local connection data for a local short-range network, e.g. WiFi or Bluetooth, to a public server (101). During the journey, one or more user terminals (112) request (220) and gets (224) the connection data, and can thereby submit (230) a digital passenger ID to the vehicle server (160). The passenger IDs are added to a passenger list (162). At the end of the journey, the vehicle server (160) counts the number of distinct passenger IDs in the, and submits (240) the passenger count to the public server (101). An alternative embodiment comprises an ID-card and USB cable instead of a short-range private network.

### BACKGROUND

### Field of the Invention

The present invention concerns a system and a method for counting passengers in a road vehicle.

### Prior and Related Art

Road traffic causes local air pollution with adverse effects on public health and/or the environment. For example, road vehicles with combustion engines emit NOₓ at ground level, which is an important precursor to ground level ozone or smog. All road vehicles stir up dangerous airborne particles, e.g. PM₁₀. Smog and dangerous airborne particles are known to cause premature death. Thus, reducing road traffic is likely to improve air quality and public health, especially in densely populated areas.

In urban and suburban areas, adequate public transport may reduce commuting by private cars and thereby reduce air pollution, road wear and need for parking space. However, public transport may be too infrequent and/or expensive for commuters living in a suburban or rural area. Thus, local authorities may encourage people living in such areas to share a vehicle. For example, neighbours or colleagues may take turns driving to work on different days with each other as passengers. Since 2011, a mobile application termed “HentMeg” has connected passengers in areas around Bergen, Norway with vehicles going to a destination specified by the passenger. This application saves traveling time and road traffic.

Local authorities may also allow vehicles with several passengers (high occupancy vehicles—HOVs) in lanes otherwise reserved for public transport and/or reduce tolls for HOVs in high occupancy toll lanes (HOT-lanes), etc. Such systems are generally known as HOV/HOT-systems, and count passengers in a vehicle automatically to avoid problems with drivers reporting passenger count. Counting systems using cameras and automatic image analysis are avoided for privacy reasons.

Our co-pending Norwegian patent application, Attorney docket 0316.02.NO.005, entitled “System for controlling traffic” describes a passenger discount on usage and pollution based fees. The passenger discount is based on the number of passengers in a journey, e.g. from home to work or vice versa. Passengers may be authenticated by so-called multi-factor authentication. An ATM application is a familiar example of two-factor authentication in which a customer is allowed to withdraw a limited amount based on ‘something he has’ the banking card, and ‘something he knows’, a PIN. A net banking application potentially involves larger amounts, e.g. a social security number, an electronic device, a password and possibly an additional SMS-confirmation for amounts above a predefined limit. Other widely used factors include one-time tokens received in an SMS-message and biometric data such as fingerprint, iris scan or voice.

A passenger is present in a vehicle during a journey, but the passenger's identity is not required to qualify as passenger. Thus, some proposed HOT/HOV systems depend on sensors within the vehicle. For example, EP 2 472 289 B1 proposes using a Doppler radar to detect signal patterns typical for breathing or heartbeats, and determine a passenger count based on the detected signals. Other systems include sensors to detect weight, infrared radiation, ultrasound or radar signals. Some of these sensors are already present in current vehicles, e.g. in systems for adaptive seats and/or airbag control. However, many vehicles must be upgraded with sensors and/or significant processing power for such systems.

Some mobile messaging operators offer mobile ticketing, i.e. a possibility to order, buy and/or validate tickets for public transport etc. by sending an SMS message, by a custom application or on a web site. The returned ticket may be, for example, an MMS-message containing a QR-code or an SMS-message confirming a valid ticket. A passenger might order or validate a “free” ticket for a journey in a private vehicle, and thereby be counted as a passenger for the journey. However, mobile ticketing systems are relatively complicated and expensive. This may reduce revenue otherwise available for traffic or environmental purposes, e.g. public transport, roads etc. Alternatively, a commercial messaging provider may offer traffic authorities an inexpensive system, and expose the passengers to more or less customised commercials and spam.

A general purpose of the present invention is to solve or reduce at least one of the problems above while retaining the benefits of prior art. A specific purpose is to provide a user-friendly and reliable system and method for counting passengers in a road vehicle, e.g. for a passenger discount and/or a HOV/HOT-system.

### SUMMARY OF THE INVENTION

This is achieved by a system for counting a passenger in a road vehicle according to claim 1 and a corresponding method according to claim 9. Additional features and benefits appear from the independent claims.

In a first aspect, the invention concerns a system for counting passengers in a road vehicle. The system comprises a public server for recording a journey ID and an associated passenger count; a vehicle server within the vehicle and a machine-readable passenger token for providing a passenger ID unique for each passenger. The public server and the vehicle server are nodes in a public network. The public server is configured to record the passenger count as the number of distinct passenger IDs that is/are read by the vehicle server over a short-range connection during a journey identified by the journey ID.

The public server is a process running at a central site, and is available over a public network from the vehicle server. The machine-readable passenger token provides a passenger ID that defines the passenger uniquely within the system. Suitable passenger IDs include, for example, an unencrypted or encrypted social security number and/or an ID based on biometric data. The short range-connection ensures that the passenger token is close to the vehicle server inside the vehicle. A passenger list or similar structure collects the passenger IDs of the passengers registering for the journey. Duplicate entries are rejected or removed from the list. At the end of the journey, the passenger IDs in the list are counted, and the resulting passenger count is stored in the public server for further use, e.g. for computing a passenger discount or automatic control in a HOT/HOV-system.

If desired, standard multi-factor authentication may confirm that the passenger is in the same place as the passenger token with an appropriate degree of certainty. For example, a USB-cable may connect an inexpensive card reader to read a passenger ID from a personal card. In this case, the passenger may enter a PIN on the vehicle server to verify that he or she is inside the vehicle. In other embodiments, other factors may authenticate the passenger.

Preferably, the journey ID comprises a vehicle ID and an expiration. The vehicle ID, e.g. a registration number, uniquely defines the vehicle used for the journey. The expiration is a fixed time, e.g. three hours from the start of a journey or 11:00 each working day. The expiration differentiates several journeys in one vehicle.

The vehicle server may be a process running in a driver's mobile terminal, e.g. a smartphone or tablet. This allows rapid and inexpensive deployment of the system, as the driver may simply download and install a server application to be eligible for a benefit, e.g. a passenger discount or a right to drive in a HOT lane.

Alternatively, the vehicle server may be a process running in a secure device mounted in the vehicle. This embodiment facilitates integration with sensors for computing usage based fees.

The machine-readable passenger token may be a personal card associated with the passenger. This embodiment is particularly useful in areas where most or all citizens have a personal ID-card with a unique ID identifying the card holder. Some governments issue such ID-cards. However, it would be rather expensive to provide a personal ID-card to all potential passengers in an urban and suburban area. Moreover, visitors to the area might lack a personal ID-card, but still qualify as passengers.

Any suitable machine-readable device able to provide the passenger ID may be used as passenger token. However, as most passengers carry a smartphone or a similar mobile device, the machine-readable passenger token may conveniently be a user terminal forming a node in the public network, in this case a mobile network. Smartphones etc. may be used as passenger tokens in addition to or as alternatives to personal cards.

If a smartphone or other user terminal is used as machine-readable passenger token, the short-range connection is preferably a wireless short-range network, as it might be impractical to connect each user terminal by a cable for registering a passenger. However, any known and suitable connection, e.g. an infrared link, is anticipated.

The public server, the vehicle server and each user terminal advantageously comprises a private key that remains secret within the node at all times, a corresponding public key available to any other node and cryptographic primitives for encrypting and decrypting a message. This allows secure communication over the public network, and prevents eavesdropping on a short-range wireless network. Proven protocols, e.g. transport layer security (TLS) protocols use such keys and are widely used in the Internet, e.g. for secure communication between a secure HTTPS site and a web browser, and on private WiFi networks. The present invention may be implemented using SMS text messages, which are unencrypted and thus do not require keys.

A user terminal used a passenger token may further comprise a digitally signed certificate containing its public key and one passenger ID. The certificate may be generated in a one-time registration procedure that allows more extensive authentication of the passenger than the authentication described previously. For example, the traffic authority may lookup a name and social security number in a central register to verify and/or generate a passenger ID, and then sign the certificate digitally. Once installed or copied to a user terminal, the signature can be checked at regular or random intervals by the vehicle server to ensure that the certificate has not been tampered with, and hence that the passenger ID is valid. The software implementing the vehicle server may itself be signed to prevent tampering. In addition, some current platforms will not load or run software without a valid signature.

The personal certificate may be copied legitimately to several devices, e.g. a personal smart phone, a tablet and/or a job phone used by one passenger. The user can be made responsible for any use of his personal certificate if it is compromised, unless he or she revokes the certificate. This would imply a central register of revoked certificates.

A second aspect of the invention concerns a method for counting passengers in a road vehicle. The method comprises the steps of:
creating a data structure ‘journey’ identified by a unique journey ID and comprising an empty passenger list in a digital storage medium;
reading a passenger ID from a machine-readable passenger token;
submitting the passenger ID over a short-range connection to a vehicle server within the vehicle;
adding a distinct passenger ID to the passenger list and
submitting the journey ID and a number of distinct passenger IDs to a public server over a public network.

The empty passenger list may be created in a digital storage medium associated with the vehicle server or the public server. The journey ID preferably comprises a vehicle ID and an expiration as described above. The expiration time should separate commuter traffic in the morning from commuter traffic in the evening. The few vehicles traveling into a city and back before the journey expires is expected to be small, and need no special consideration. Creating a new journey may terminate any previous journey registered to the vehicle in order to prevent one passenger from registering several times in parallel ‘journey’ data structures.

Creating the data structure ‘journey’ may include storing a vehicle ID and local connection data in the public server. Thereby, the user terminal of a random passenger may fetch the local connection data from the public server and connect automatically to the vehicle server. Otherwise, the passenger would have to enter connection data for a private network, e.g. an SSID and passphrase or WPA-code for a WiFi network manually. The local connection data must be encrypted to prevent a malicious third party from gaining access to the private network. The encryption may include a one-time token and thereby be different for every journey. So-called ephemeral protocols for this purpose are well known, e.g. from TLS.

Reading the passenger ID may include authenticating the passenger. Two-factor authentication should suffice for the present invention if the amounts involved in a passenger discount or value of driving in a HOT-lane are comparable with the amounts available for withdrawal in an ATM. As noted, a PIN entered on the vehicle server's console would verify that a person knowing the PIN, presumably the card owner, is present in the vehicle. A user terminal 112 might receive a one-time token by SMS and enter the one-time token on the vehicle server in a similar manner. We note that a private key on the user terminal may be protected by a passphrase. However, such a passphrase must be entered on the user terminal and does not prove that the passenger entering the passphrase is near the vehicle server. Thus, a passphrase for the private key is merely inconvenient for the present invention.

The method may further comprise a step of issuing a receipt for the journey. Such a receipt might enable the passenger to gain a benefit in addition to saving travelling time.

Preferably, the method further comprises a step of requesting an end of journey before a fixed expiration. This enables the driver to submit the passenger count and delete private data once the vehicle arrives at the final destination.

If the driver forgets or neglect to submit the passenger count, the fixed expiration associated with the journey ensures that the passenger count is submitted to the public server. When the driver manually ends the journey or at the expiration, the journey ID and passenger count is recorded in the public server. Then, the passenger IDs in the passenger list, the ephemeral token, the local connection data, any information that may identify a passenger and other private data are no longer needed, and should be deleted from the public server and vehicle server.

Private networks, e.g. WiFi, comprise secure channels preserving integrity and confidentiality. Secure channels are established by exchanging tokens to agree on a common secret key for a session. The common key is used for effective secure communication during the session. On a public network, the handshaking to establish secure channels, e.g. between a web browser and a public HTTPS-server, demand computing power and hence battery power. The present invention does not need the resulting secure channels, so each message transmitted over the public network and/or the short-range connection may simply be encrypted with a sender's private key or a recipient's public key. Either way, the corresponding key in the key pair is used for decryption. Using the sender's private key for encryption may save a request for a public key, and proves the origin of the message: If the message can be decrypted with a public key, the sender must have access to the private key.

As above, a certificate may connect the public key to a passenger ID.

### BRIEF DESCRIPTION OF THE DRAWINGS

The invention will be explained with reference to exemplary embodiments and the accompanying drawings, in which

FIG. 1 illustrates a system for charging usage fees to a vehicle,

FIG. 2 illustrates the system and method of the present invention and

FIG. 3 is a block diagram showing details of the method in FIG. 2.

### DETAILED DESCRIPTION OF A PREFERRED EMBODIMENT

The drawings are schematic and not to scale. For ease of understanding, numerous details known to a skilled person are omitted from the drawings and the following description.

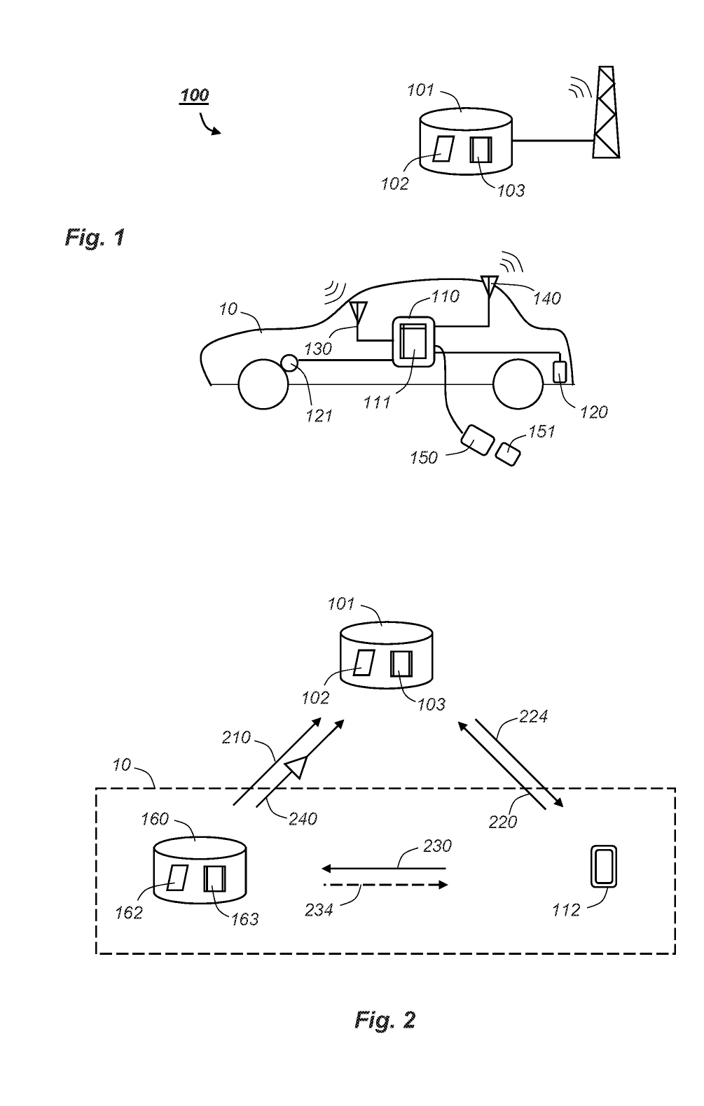

FIG. 1 illustrates a system 100 for charging fees disclosed in our co-pending application NO20160003A1. A central system comprises a public server 101 with associated data 102 and predefined processes 103, e.g. for collecting fees. A secure device 110 mounted in a vehicle 10 collects emission data from an emission sensor 120, a mileage from an odometer 121 and positioning data from a GPS-receiver 130. The fee data may be transmitted over a public network 140, e.g. a mobile network, to the public server 101 for computing fees. Alternatively, the secure device 110 may store the data in an internal file system 111 and compute the fees. In this case, no sensitive data such as positions with associated times are sent to the central system 101.

A user terminal 112, e.g. a smartphone, tablet, PDA and/or a laptop is able to communicate over the public mobile network 140, e.g. with the public server 101. The user terminal 112 is also able to communicate via short range links, e.g. a USB cable or a private and/or personal area network such as WiFi or Bluetooth.

In a first embodiment of the present invention, each passenger has a unique ID-card identifying the owner. A card reader 150 is connected to the secure device 110, e.g. by a USB-cable. A person may insert a personal card 151 into the reader 150 and enter a PIN to verify that he or she is the owner of the card. The card reader 150 should read a passenger ID unique for the owner. The card and PIN is an example of two-factor authentication suitable for connecting a person to a digital passenger ID. The USB-cable connects the card reader, and thereby the authenticated person, to the vehicle 10. This prevents someone in a remote location from registering as passenger for a journey.

The unique passenger ID read by the card reader 150 is added to a passenger list for counting passengers as further described below. Some private and public organisations provide machine readable cards, e.g. tickets issued by public transport companies, smart cards for banking applications or secure networking or ID-cards issued by some governments. However, large scale distribution of new smart cards or electronic devices comprising a unique passenger ID for a traffic application is expensive.

FIG. 2 illustrates an alternative embodiment, in which a passenger's user terminal 112, e.g. a smartphone, tablet, PDA or laptop replaces the ID-card as a factor in authenticating the passenger. The main benefit is that all passengers are likely to carry such a device in a journey from home to work or back. A vehicle server 160 comprises a passenger list 162 and processes running in the vehicle 10, e.g. in a secure device 110 of the system 100 or in a mobile device 112 belonging to a driver of the vehicle 10. A short range network, e.g. WiFi or Bluetooth, provides the short range connection between the user terminal 112 and the vehicle server 160, and thereby associates the user terminal 112 with the vehicle 10 for the journey.

FIG. 2 also illustrates the main steps in a method 200 for counting passengers. In step 210, the vehicle server 160 creates a ‘journey’ data structure identified by a vehicle ID and a fixed expiration. The newly created data structure ‘journey’ comprises an empty passenger list, and is preferably created in the vehicle server 160 to save traffic over the public network 140. The passenger list may have a maximum number of items, e.g. the number of passenger seats in the vehicle.

In embodiments with a private, local net, the step of creating 210 a data structure may involve sending local connection data for the vehicle server 160, e.g. an SSID and a passphrase for a WiFi network, to the public server 101. In response, the public server 101 stores the local connection data for the vehicle server 160.

Step 220 is performed for every passenger registering during the journey, and comprises a request for local connection data for the vehicle server 160. The public server 101 returns a message 222 with the requested data, and the user terminal 112 is able to connect directly to vehicle server 160. There is no need for manual input or reconfiguration for WiFi, Bluetooth etc. in the user terminal 112 and/or vehicle server 160. This facilitates use of the present invention for the driver and regular passengers as well as for a random passenger registering for one journey in the vehicle 10.

In step 230, the passenger's user terminal 112 submits a passenger ID unique to the person possessing the user terminal 112. The vehicle server 160 may respond 234 with a receipt for registering as passenger for the journey. The optional step 234 enables the owner of user terminal 112 to document several journeys in a certain period and/or collect a small amount for motivating people to register as passengers, e.g. in commuter traffic.

One of the processes 163 in the vehicle server 160 checks for duplicate passenger IDs in a passenger list. For example, a passenger ID associated with the driver of the vehicle 10 should not increase the passenger count. A passenger submitting his or her passenger ID more than once during a journey, possibly from different user terminals 112, should receive a message that he or she is already registered for the journey. Thus, there is no need for fines or other expensive enforcement to prevent fraud, and a function to confirm registration on the user terminal 112 becomes optional.

In step 240, the vehicle server 160 submits the passenger count to the public server 101. The passenger list containing passenger IDs and other private data are not needed for counting a number of passengers, and are thus deleted from the vehicle server 160.

In a passenger discount system, the vehicle ID and an expiration time are required to identify a journey, and the passenger count is needed for computing the discount. A public server 101 is required to collect and compute fees and discounts

A HOT/HOV system may further comprise fixed and/or mobile control points. Each control point may comprise a camera connected to an automatic number-plate recognition (ANPR) system. The camera may be placed near the ground to avoid taking pictures of passengers, and also to focus on the HOT-lane rather than adjacent ordinary lanes. The registration number can later be checked against the passenger count stored in the public server 101. Alternatively, the vehicle server 160 might be required to report the current passenger count in real time. However, the value of real time reporting over comparing e.g. three hours later is limited, unless the passenger count is controlled manually a few hundred meters past the control point. Either way, a public server 101 is required to collect fees or record violators.

The scheme illustrated in FIG. 2 eliminates the need for entering local connection data manually and/or reconfiguring the vehicle server 160 to accommodate a random passenger. As the public server 101 is required anyway, it is relatively inexpensive to make it provide local connection data.

The communication over the public network 140 may be conducted on any network layer using any suitable protocol. For example, the driver's request in step 210 might use SMS on a mobile network 140 to send a code word and vehicle ID to a predefined number, e.g. “jstart AB12345” to number 9876. Alternatively, the request 210 may connect to a webserver on the application layer, e.g. by an URI such as “https://example.com/AB12345”, which includes the vehicle ID. The URI may be available from the ‘Favourites’ folder in a web browser, a QR-code on a console or a sticker in the vehicle 10, etc.

A dedicated application downloaded from a central store and installed on the user terminal is a practical alternative regardless of protocol and algorithm. Such an application may have options for registering as a driver or a passenger, and use system calls to access data and functions, e.g. the passenger ID or functions for encryption, decryption and hashing. A dedicated application may be signed by the issuer, and thereby cryptographically hard to modify. Proven cryptographic techniques may easily make the cost of reading or altering data or the software orders of magnitude larger than the gain obtainable from reading or altering a passenger count, and thus make eavesdropping or malicious alteration uninteresting or impossible for everyone with the possible exception of state level adversaries.

Specifically, encryption keeps the content of a message confidential, whereas hashing ensures the integrity of the contents. Digital nonrepudiation includes determining origin of data with reasonable certainty. For example, encryption ensures that an eavesdropper on the network 140 cannot see a passenger's approximate position at a certain time. Hashing ensures that neither software nor the passenger count sent to the public server can be altered without being detection. Thus, the driver cannot be suspected for manipulating the passenger count. Nonrepudiation enables the authority operating the public server 101 to prove that a certain vehicle server 160 sent a certain passenger count, and that the authority could not possibly have altered the passenger count after reception.

For encryption, hashing and providing nonrepudiation, the public server 101, vehicle server 160 and each user terminal 112 are provided with unique pairs of cryptographic keys. Each key pair comprises a private key and a corresponding public key. A message encrypted with a public key can only be decrypted using the associated private key. The public key cannot decrypt the message, and is available to all communication partners, e.g. as part of a message or on request. Similarly, the public key can decrypt a message encrypted with a private key. Thus, if a message decrypted with a public key is readable, the sender must have access to the private key. The key pair eliminates a need for a central register of secret keys and secure channels, e.g. couriers, to distribute secret keys. The security depends on that the private key remains secret at all times.

Keys preinstalled in the SIM-card of a mobile device are usually not used for authentication, as there is no way to know if the alleged private keys are actually secret. However, current SIM-cards may comprise useful cryptographic primitives, e.g. secure functions for encryption, decryption, hashing or a combination. These functions run in a protected smart card, and are invoked by some mobile banking applications. The transport layer security (TLS) protocols for Internet applications define suitable algorithms and recommendations for encryption, hashing etc.

A first implementation may use readymade functions for handshaking, encryption and hashing, e.g. as defined in current TLS protocols. For example, messages may be provided with a digital signature. However, computing a digital signature involves hashing and encryption, and hence requires relatively large computing resources and thereby battery power. Alternatively, a Diffie-Hellman handshaking algorithm may be used to establish a secure channel through a public network. Once established, the secure channel is suitable for exchanging large amounts of data, e.g. by combining hashing and encryption in the Galois/Counter mode (GCM) of the AES block cipher defined in TLS from version 1.2. However, secure channels are not needed for the small amounts of data in the present application. Rather, a minimal connection procedure is preferred to save battery power, e.g. for environmental reasons.

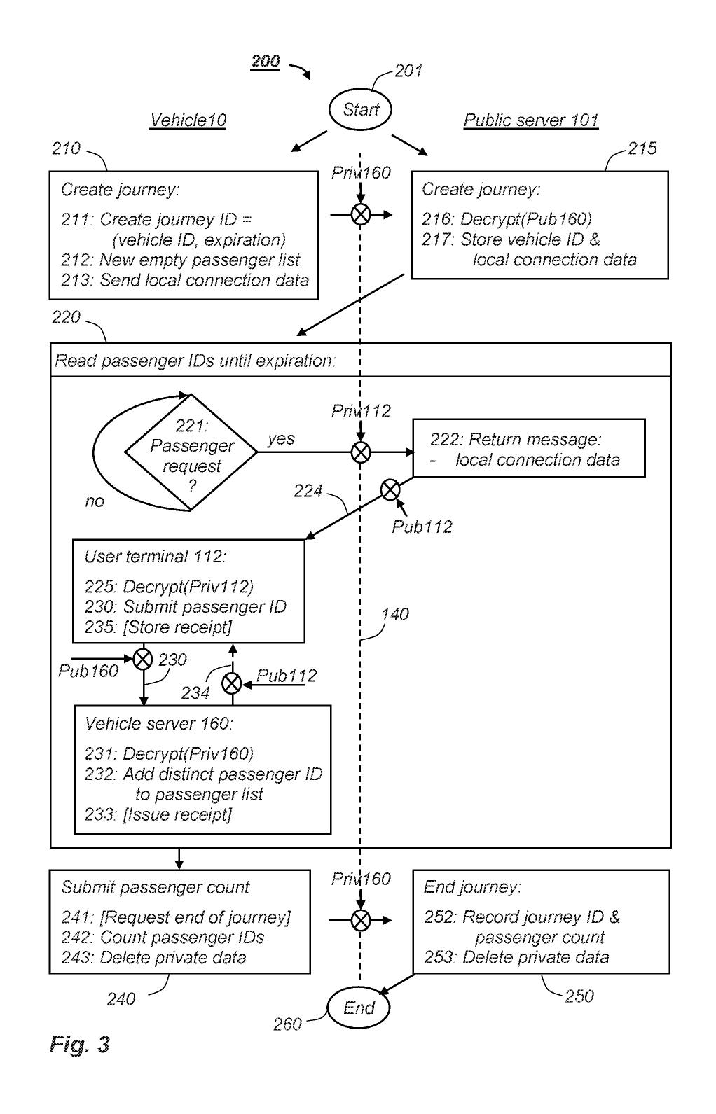

FIG. 3 is a block diagram illustrating details of a minimal secure embodiment using user terminals 112 with private and public keys. A verifiable, unique passenger ID is required in all embodiments, e.g. in the user terminals 112 and the personal cards 151 described above. A social security number is a good candidate for a passenger ID, because it is preassigned to all citizens and may be verified by a lookup in a central database. If desired, the social security number may be encrypted for use as a passenger ID.

In FIG. 3, a dashed vertical line represent the public network 140. Steps performed in the vehicle or over local, short-range network associated with the vehicle server 160 are shown to the left of the dashed line 140. Steps performed in the public server 101 are shown to the right of the dashed line 140.

Step 201 represents steps performed before starting the journey, e.g. installing a application on user terminals 112 and the vehicle server 160. The application may be secure in the sense that it will not run without a valid signature to prove origin and integrity. Step 201 may also include an option to associate a vehicle ID with a driver to facilitate later use, e.g. such that the public server 101 uses the vehicle ID as default if the driver logs in. The vehicle ID may be associated with a mobile number and/or a passenger ID on a secure website using any web browser.

The passenger ID and secure keys are also initialised in step 201. According to best practice, a user may generate a key pair and submit the public key along with his social security number and name to the traffic authority operating the public server 101. In return, the user gets a signed public key certificate with a passenger ID. The certificate cannot be altered without detection, and thereby associates the public key with a passenger ID corresponding to a user that at least can connect a name and a social security number. The private key does not leave the user terminal during this process. The certificate can be copied to several devices along with the private key, e.g. by using a memory stick, and thereby associate the user with several user terminals. Thus, the passenger may register using a personal smart phone one day and his job phone the next, but neither the passenger nor the driver can increase the passenger count by using several devices with the same passenger ID.

Block 210 illustrates steps performed in the vehicle server 160 when creating a new ‘journey’ data structure. Specifically, step 211 defines the journey ID as a vehicle ID and an expiration, and step 212 creates an empty passenger list on the vehicle server 160 as explained previously. Step 213 includes collecting and sending local connection data for the short range network associated with vehicle server 160. The local connection data could be, for example, an SSID and a catchphrase for a WiFi network or a pin for a Bluetooth connection.

The expiration sets a latest time for registering as passenger for the journey, and for submitting the passenger count to the public server 101. The expiration will not change if the driver manually stops the passenger count, and ensures that the vehicle server 160 submits the passenger count if the driver forgets or ignores to submit the passenger count manually.

The expiration may be set relative to the start of the journey, e.g. three hours from the driver's request 210 for a new journey. Alternatively, the expiration could be a fixed time of day, e.g. 11:00 on working days for commuter traffic in the morning and 19:00 on working days for commuter traffic in the afternoon. In both examples, the expiration separates morning traffic from evening traffic.

The vehicle server 160 encrypts the request message with its private key, i.e. Priv160, and sends the encrypted message over the public network 140 to the public server 101. Only the vehicle server 160 knows its private key, so the private key proves the origin of data with one encryption as illustrated by step 216 below. In contrast, using the public server's 101 public key for encryption would require further steps to validate the vehicle server 160 and/or the vehicle ID.

Block 215 shows steps performed in public server 101. Block 215 may advantageously comprise steps to terminate any previous journey for the vehicle ID in order to prevent a driver or passenger to register in several journeys in one vehicle at any time. This does not exclude a passenger from registering for a new journey before the expiration of the previous journey, because passengers may legitimately ride along with two vehicles within the fixed expiration time associated with the first journey.

Specifically, step 216 includes decrypting the message using the public key of vehicle server 160. If the decrypted message is readable, the sender must have had access to the corresponding private key for encryption. This establishes the vehicle server 160 as origin of the request, and thereby validates the vehicle ID for the journey.

In step 218, the public server 101 stores the local connection data provided from block 210. Thereby the local connection data becomes available for user terminals 112 from the public server 101. This eliminates the need to enter local connection data manually and/or to reconfigure devices as explained above.

Block 220 illustrates that one or more passengers may connect to the vehicle server 160 before expiration. The connection from a user terminal 112 to the server 160 is over a short-range network, so no user terminal 112 outside the range can register a passenger.

Step 221 illustrates a waiting loop that does nothing until a passenger requests registration for the journey. The passenger request must of course contain data identifying the vehicle server 160 to enable the public server 101 to return the appropriate local connection data. This may be achieved in a practical manner by sending an SMS text message, scanning a QR code etc. as described with reference to the journey request 210. Optionally, the request message may comprise the public key Pub112 of the user terminal 112 for encryption in step 224. For clarity of illustration, the passenger request message is not shown explicitly in FIG. 3.

The passenger request message is encrypted with the appropriate user terminal's 112 private key. The passenger is not responsible for the passenger count, so nonrepudiation is not required. Thus, the public server's public key Pub101 could equally well be used for encryption. The user terminal's 112 private key Priv112 is used to save a lookup for Pub101. A step of decrypting the message with the corresponding public key Pub112 is required, but not shown for clarity of illustration.

In step 222, the public server 101 returns a message containing local connection data for connecting to the vehicle server 160 over the short-range network. The message may optionally contain the expiration and/or other information. The expiration enables the user terminal 112 to inform a passenger that he or she is already registered as passenger for the journey without asking the vehicle server 160 for confirmation.

Step 224 illustrates encryption of the return message from step 222 with the user terminal's 112 public key Pub112. The public key Pub112 may be part of the passenger request message as explained above. Alternatively, the server 101 may request Pub101 from the requesting user terminal 112 using an address implicit in the request, e.g. a mobile phone number in the SMS example or an IP-address in the Internet example.

In step 225, the user terminal 112 decrypts the return message using its private key Priv112. The local connection data from the decrypted return message enables the user terminal 112 to connect to the vehicle server 160 over the short-range local network. User terminals 112 without access to the appropriate private key Priv112 are unable to decrypt the return message. Any user terminal 112 may connect to the vehicle server 160 by manual input of local connection data, so the public server 101 does not authenticate the user terminal 112.

In step 230, the user terminal 112 submits a passenger ID to the vehicle server 160. The associated message is encrypted with the public key Pub160 of the vehicle server 160. In step 231, the message containing the passenger ID is decrypted using the corresponding private key Priv160. Apart from hiding the passenger ID from an eavesdropper within range of the local short-range network, the encryption in step 230 forces an adversary to obtain the public key Pub160 and encrypt a message with Pub160. If the message is not properly encrypted, the decryption in step 231 will return garbage. Successful decryption may be determined by testing the passenger ID. For example, the vehicle server 160 may reject a decrypted passenger ID that does not match a predefined pattern of ASCII-characters representing digits and/or characters in a real passenger ID, or does not compare to a passenger ID fetched from a certificate in the user terminal 112. The cost of providing a proper encryption or modifying the software of vehicle server 160 can easily be made to exceed the obtainable benefit as discussed previously.

Step 232 adds a unique passenger ID to a passenger list. The list may have a maximum length corresponding to the number of seats in the vehicle 10. The appropriate number of seats can, for example, be fetched from a central database and stored during installation of the vehicle server 160. If the passenger ID submitted in step 230 is already present in the list, the submitted passenger ID is not unique in the list, and will not be added. In other words, duplicate passenger IDs will be rejected to ensure that one passenger registers once per journey. Preferably, the vehicle server 160 or user terminal 112 informs a passenger registering for the second or subsequent time that he or she is already a registered passenger for the journey. Thus, a separate ‘confirmation function’ is not needed in the user interface.

In an optional step 233, the vehicle server 160 issues a receipt for the journey to the requesting user terminal 112. Such a receipt may be used to provide a benefit to the owner in order to motivate people to register as passengers. Step 234 illustrates encrypting the optional message with the public key Pub112 of the user terminal 112. The user terminal 112 may decrypt the message as in step 231, and store the receipt in optional step 235 for later use.

The driver may end the journey manually in step 241. Then, the vehicle server 160 immediately counts 242 the passenger IDs in the passenger list, and then deletes 243 private data. If the driver does not end the journey manually, the vehicle server 160 executes step 242 to submit the passenger count at the expiration time. Either way, the vehicle server 160 encrypts the message containing the passenger count with its private key Priv160.

Block 250 illustrates end of journey, where the public server executes step 252 to record the passenger count for the journey identified by the vehicle ID and expiration. As noted, the expiration is unaffected by a manual request to end the journey in step 241. Step 253 deletes private data, e.g. the local connection data, from the public server 101 as they are no longer needed.

The process ends in step 260, which includes any subsequent steps required for computing a passenger discount, verifying passenger count after a an automatic control in a HOT lane, etc. from the fees charged during a journey and the passenger count.

While the invention has been described by way of examples, various alternatives and modifications will be apparent to one skilled in the art. The invention is defined by the accompanying claims.

1-15. (canceled)

16. A system for counting passengers in a road vehicle comprising:
a public server configured for recording a journey ID and an associated passenger count;
a vehicle server within the vehicle; and
a machine-readable passenger token for providing a passenger ID unique for each passenger, wherein the public server and the vehicle server are nodes in a public network, and the public server is configured to record the passenger count as the number of distinct passenger IDs that is/are read by the vehicle server over a short-range connection during a journey identified by the journey ID.

17. The system according to claim 16, wherein the journey ID comprises a vehicle ID and an expiration.

18. The system according to claim 16, wherein the vehicle server is a process running in a secure device mounted in the vehicle.

19. The system according to claim 16, wherein the vehicle server is a process running in a driver's mobile terminal.

20. The system according to claim 16, wherein the machine-readable passenger token is a personal card associated with the passenger.

21. The system according to claim 16, wherein the short-range connection is a wireless short-range network.

22. The system according to claim 16, wherein the machine-readable passenger token is a user terminal forming a node in the public network and comprising a private key and a corresponding public key.

23. The system according to claim 22, wherein the user terminal further comprises a digitally signed certificate containing its public key and one passenger ID.

24. A method for counting passengers in a road vehicle, comprising the steps of:
creating a data structure ‘journey’ identified by a unique journey ID and comprising an empty passenger list in a digital storage medium;
reading a passenger ID from a machine-readable passenger token;
submitting the passenger ID over a short-range connection to a vehicle server within the vehicle;
adding a distinct passenger ID to the passenger list; and
submitting the journey ID and a number of distinct passenger IDs to a public server over a public network.

25. The method according to claim 24, wherein creating data structure ‘journey’ includes storing a vehicle ID and local connection data in the public server.

26. The method according to claim 25, wherein reading the passenger ID includes authenticating the passenger.

27. The method according to claim 25, further comprising a step of issuing a receipt for the journey.

28. The method according to claim 25, further comprising a step of requesting an end of journey before an expiration.

29. The method according to claim 25, further comprising the steps of recording the journey ID and passenger count in the public server and deleting private data from the public server and vehicle server.

30. The method according to claim 25, wherein each message transmitted over the public network and/or the short-range connection is encrypted with a sender's private key or a recipient's public key.
